(19) United States
(12) Patent Application Publication
(10) Pub. No.: US 2008/0144610 A1
(43) Pub. Date: Jun. 19, 2008

(54) THIN CLIENT SYSTEM AND COMMUNICATION APPARATUS

(76) Inventor: Hiroyuki Kakiuchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/869,263

(22) Filed: Oct. 9, 2007

(30) Foreign Application Priority Data
Dec. 14, 2006 (JP) 2006-337353

(51) Int. Cl. H04L 12/66

(52) U.S. Cl. 370/352; 379/201.01

(57) ABSTRACT

In a TC system, there are provided a softphone and a communication system capable of automatically switching an operation mode in accordance with the environment of a system user. A module of a TC-version softphone and a module of a normal-version softphone are configured as one softphone, so that when using a TC terminal, the softphone functions as a TC-version softphone, and when using separately a PC placed on a user's desk, the softphone functions as a normal-version softphone. Further, there is provided means for monitoring and determining a state of connection or disconnection of the TC terminal used in the TC system, so that an operation mode is automatically switched for processing in accordance with the environment of a system user.

### CLAIM OF PRIORITY

The present application claims priority from Japanese patent application serial no. 2006-337353, filed on Dec. 14, 2006, the content of which is hereby incorporated by reference into this application.

### BACKGROUND OF THE INVENTION

The present invention relates to a thin client system and a communication apparatus, and particularly to a thin client system and a communication apparatus in which operations are changed depending on connection or disconnection of a client.

In recent years, IP phones are rapidly spreading. As an example, a basic configuration of a company's IP phone system will be described using FIG. 1. FIG. 1 is a block diagram of a company's IP phone system. In FIG. 1, a telephony server 800 serves as PBX, and controls a call between phone terminals. The phone terminal includes an IP phone 801 connected to an IP network 840 and a softphone 812 which is a phone program on a personal computer (PC) 810. The softphone 812 allows the PC, which is usually executed by a user himself/herself, to perform a call dialing/receiving operation as a user's phone terminal. A handset 811 serving as a phone receiver for the softphone 812 is connected to the PC 810. In addition, by providing a function of transmitting/receiving video with the use of a camera 813 as a part of functions of the softphone 812, the PC 810 can be also used as a TV phone terminal and a TV conference terminal.

The IP phone can be communicated with a general phone 831 through a land phone network 830 by interposing a gateway apparatus 820. The IP phone can be also communicated with a cellular phone 833 via a cellular phone network 832.

A basic operation of the IP phone will be described with an example of making a dial call from the phone terminal 801 to the soft phone 812. When dialing from the phone terminal 801, the telephony sever 800 receives the call as call dialing information from the phone terminal 801. The telephony server 800 confirms a call state and the like of the softphone 812, and then notifies the phone terminal 801 and the softphone 812, of an IP address 843 of the softphone 812 and an IP address 842 of the phone terminal, respectively. Thereafter, the both phone terminals mutually transmit and receive voice packets to/from each other by use of their IP addresses, and are connected to each other so as to realize voice communications. It should be noted that the softphone 812 for use on the PC described herein is referred to, hereinafter, as “normal-version softphone” so as to definitely distinguish the softphone 812 from the other in the following description.

Meanwhile, an information leak has become a major concern in recent years. The personal information protection law has been applied to private companies and has thoroughly come into effect since Apr. 1, 2005. However, there is no end to news reports on a personal information leak and a customer information leak. The occurrence of an information leak not only incurs enormous cost for countermeasures and compensations for the leaked information, but also deteriorates the credibility of a company that has caused the information leak. Thus, the information leak is a major concern which has an impact for a long period of time, and risks the existence of the company.

In such a situation, a thin client has been drawing attention, as one of countermeasures for preventing data loss and data leak when a PC is lost or stolen. The thin client is not capable of storing information because it is not equipped with an HDD and a recording drive. Thus, if a PC is lost or stolen by any possibility, an information leak does not occur. This point is optimum for a security countermeasure for client environment.

The outline of the thin client system can be roughly classified into two schemes of a screen transfer scheme and a network boot scheme. The screen transfer scheme has a lot of configuration patterns, so that it can be further classified into a server type, a blade PC type, and a virtual computer type depending on the kind of a computer arranged in the center of the system. In the case of considering the thin client system as a countermeasure against an information leak, the screen transfer scheme by which only screen images are transmitted is effective.

The thin client system is a system in which a thin client is combined with a blade server which is an assembly of a plurality of servers (blades), and the blade server is thought to be managed in a server room where only a permitted administrator is allowed to enter. However, when a thin client system is newly provided, two PCs (a thin client and a blade) are additionally introduced for use of the blade server. On the contrary, it is a practical choice to utilize an already-introduced PC placed on a user's desk as a server and newly introduce only a thin client.

With reference to FIG. 2, a basic thin client system (hereinafter, abbreviated as TC system) will be described. FIG. 2 is a block diagram for explaining the thin client system. The thin client system in FIG. 2 has a configuration pattern which is classified into a server type of the screen transfer scheme. As a manner of utilizing the TC system, a normal PC assigned to an individual employee which has been used to date is regarded as a server (hereinafter, abbreviated as TC server) in a user's office. When the user goes on a business trip to another location such as a branch office, the user travels with a thin client terminal (hereinafter, abbreviated as TC terminal) which is not equipped with an HDD and in which user data cannot be stored, and the user accesses the PC placed on the user's desk from the destination by use of the TC system of the screen transfer scheme. For the following description, the manner of this configuration is named as “Point to Point type”, which is abbreviated as PtoP type.

The TC system of the PtoP type includes: a TC server 720; a TC terminal 740; and a LAN 770 and a WAN 780 which are networks that connect the TC server 720 to the TC terminal 740. The TC server 720 is a PC placed on a user's desk in an office. A display apparatus 711, a keyboard 712, a mouse 713, and the like are connected to the TC server 720. The TC server 720 includes a CPU 721, a memory 722, a device control unit 723, an OS 724, a storage apparatus 725, a remote control SV (server) 726, an AP 727 that stands for application program, and the like. The TC terminal 740 includes: a main body 750 having a CPU 754, a memory 755, a device control unit 753, an OS 752, and a remote control CL (client) 751; a display apparatus 741; a keyboard 742 as an input apparatus; and a mouse 743, and includes no storage apparatus. Communication between the TC server 720 and the TC terminal 740 is established, so that the TC system functions.

Communications in the TC system are established between the remote controls in such a manner that the remote control CL 751 of the TC terminal issues a communication starting request to the remote control SV 726 of the TC server that is waiting for connection. As an IP address where the communication starting request is transmitted, there is used an IP address 730 of the TC server which is preliminarily set in a server IP address storage area 765 of the memory 755. When receiving the communication starting request from the remote control CL 751 at first, the TC server 720 stores an IP address 760 transmitted from the remote control CL 751 into a terminal IP address storage area 735 of the storage apparatus 725. Thereafter, the TC server 720 performs communications with the stored IP address. At the time of terminating the communications, the TC server 720 deletes the IP address stored in the terminal IP address storage area 735.

In a state where the communications are established between the TC server and the TC terminal, the TC system is operated as follows. Input operations with the use of the keyboard 742 and the mouse 743 of the TC terminal are transmitted from the remote control CL 751 to the TC server 720. The remote control SV 726 of the TC server 720 receives the input operations so as to transfer to the OS 724, as input information to the TC server 720. The OS 724 executes processes in accordance with the input information from the remote control SV 726, and screen information and the like which are the results of these processes are transmitted from the remote control SV 726 to the TC terminal 740. The remote control CL 751 receives the screen information and the like, and outputs the same to the display apparatus 741 via the OS 752.

When the introduction of the TC systems is advanced in the situation where the company's IP phone systems are widely spreading, there arises a natural demand to use the IP phone functions in the TC systems. However, the realization of the IP phone functions in the TC terminals of the TC systems involves some technical problems. All application programs are executed by the TC server in the TC system. Therefore, even if a softphone that is a phone program is executed by the TC server, there is no means for transferring voice to the TC terminal, and thus no communication is established. Even if the voice transfer can be realized, the voice data is delivered to the TC terminal or a destination via the TC server, which results in delay of the voice and deterioration in sound quality.

As described in Japanese Patent Application Laid-Open No. 2006-254411, there has been considered a method in which some of softphone functions are separated and are installed on each of the TC server and the TC terminal so as to realize IP phone functions in a TC system. It should be noted that the softphone described in Japanese Patent Application Laid-Open No. 2006-254411 is hereinafter described as “TC-version softphone”.

In consideration of using the softphone of the “PtoP type” in the TC system configuration described in Japanese Patent Application Laid-open No. 2006-254411, there is a problem that a call can be established with the TC terminal, but not with a PC placed on a user's desk under the environment where a TC-version softphone 100 is installed.

This problem can be solved by introducing, in addition to the TC-version softphone, a normal-version softphone that is installed when a user wishes to use phone functions on a PC to the PC placed on the user's desk. However, since two kinds of softphones are installed on the PC, the economic efficiency is reduced.

In the case where two kinds of softphones of the TC-version softphone and the normal-version softphone are installed for use on the PC placed on the user's desk, the softphone to be used is different depending on the case of using the softphone with the TC terminal and the case of using the softphone with the PC placed on the user's desk. Thus, the user needs to consciously use the both depending on the situation, which is inconvenient.

The present invention provides a thin client system and a communication apparatus in which operations are changed depending on connection or disconnection of a client.

### SUMMARY OF THE INVENTION

The above-described object can be achieved by a thin client system including: a communication apparatus to which a client can be connected via a network and which can execute an application program; and the client that accesses the application program to output the execution result, wherein the application program determines connection or disconnection between the communication apparatus and the client, and selects an operation mode depending on a determination result.

Further, the above-described object can be achieved by a communication apparatus to which a client can be connected via a network, wherein an application program is executed to determine whether or not the client is being connected, and an operation mode of the application program is selected depending on a determination result.

### BRIEF DESCRIPTION OF THE DRAWINGS

Preferred embodiment of the present invention will now be described in conjunction with the accompanying drawings, in which;

FIG. 1 is a block diagram of a company's IP phone system;

FIG. 2 is a block diagram for explaining a thin client system;

FIG. 3 is a block diagram for explaining a configuration of a softphone system;

FIG. 4 is a hardware block diagram of a TC server;

FIG. 5 is a hardware block diagram of a TC terminal;

FIG. 6A is a flowchart for explaining a starting process of the softphone;

FIG. 6B is a flowchart for explaining a termination process of the softphone;

FIG. 7 is a flowchart for explaining an operational process of a remote control determination processing unit;

FIG. 8 is a block diagram for explaining a call between a phone terminal and the TC server;

FIG. 9 is a sequence diagram of call control performed among the TC server, a telephony server, and the phone terminal;

FIG. 10 is a block diagram for explaining a call between the phone terminal and the TC terminal; and

FIG. 11 is a sequence diagram of call control performed among the TC terminal, the TC server, the telephony server, and the phone terminal.

### DETAILED DESCRIPTION OF THE PREFERRED EMBODIMENT

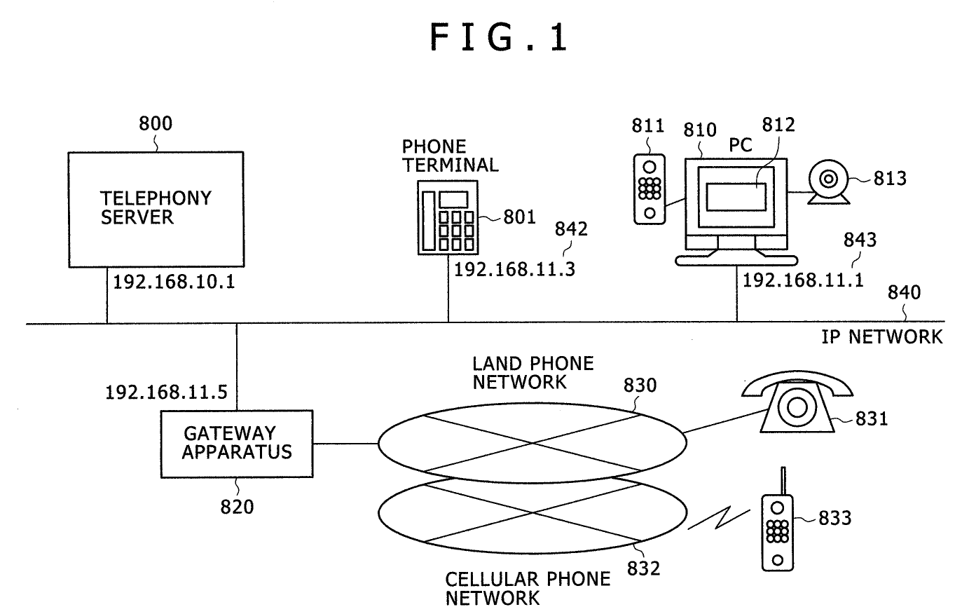

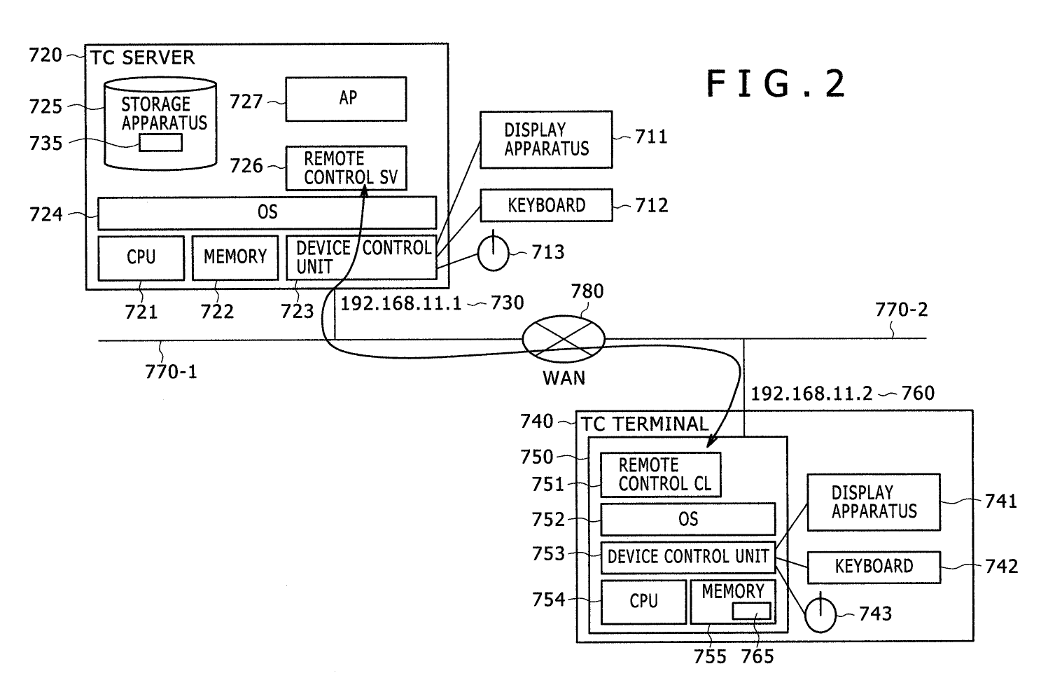

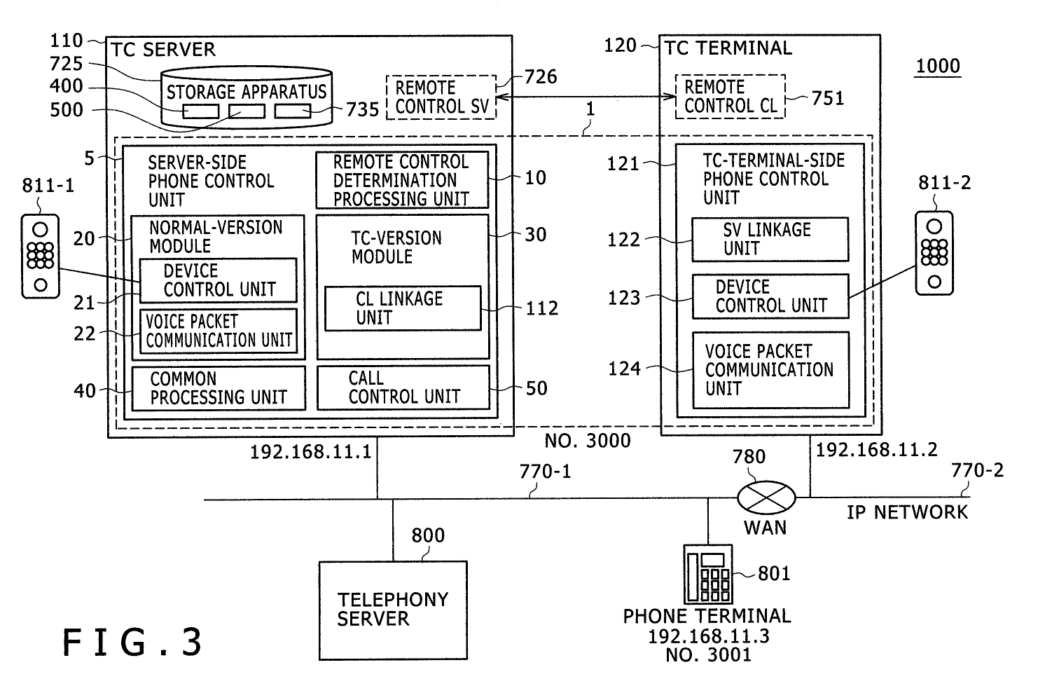

Hereinafter, an embodiment of the present invention will be described with reference to the drawings. It should be noted that the identical units are given the same reference numerals, and thus the explanations thereof will not be repeated. FIG. 3 is a block diagram for explaining a configuration of a softphone system. A difference in configuration between the softphone according to the related art and that shown in FIG. 3 is that a server-side phone control unit 111 in FIG. 1 of Japanese Patent Application Laid-Open No. 2006-254411 is replaced by a server-side phone control unit 5 in FIG. 3, and a handset 811 serving as a phone receiver for the softphone can be connected to the TC server 110. Accordingly, a user can use IP phone functions with the same extension number by use of one of the TC server and the TC terminal without being aware of a terminal to operate.

In FIG. 3, a softphone system 1000 includes: a TC server 110, a telephony server 800, and a phone terminal 801, all of which are connected to an IP network 770-1; a TC terminal 120 connected to an IP network 770-2; and a WAN 780 which connects the IP network 770-1 to the IP network 770-2. Handsets 811 are connected to the TC server 110 and the TC terminal 120.

A softphone 1 installed on the TC server 110 and the TC terminal 120 includes two programs: a server-side phone control unit 5 that is an application program installed on the TC server 110; and a TC-terminal-side phone control unit 121 that is incorporated in the TC terminal 120 so as to provide IP phone functions in the TC system by cooperating with the server-side phone control unit 5 of the TC server 110.

The server-side phone control unit 5 includes: a remote control determination processing unit 10 which determines connection or disconnection of the TC terminal of the TC system; a normal-version module 20 in which functions as a normal-version softphone are modularized; a TC-version module 30 in which functions as a TC-version softphone are modularized; a common processing unit 40 which conducts common general-purpose processes of the softphone 1; and a call control unit 50 which conducts overlapping call-control-processes in the both modules 20 and 30. The normal-version module 20 includes: a device control unit 21 which controls the handset 811-1 as a phone receiver in the IP phone functions; and a voice packet communication unit 22 which conducts a voice packet process in the IP phone functions. The TC-version module 30 includes a CL linkage unit 112.

The TC-terminal-side phone control unit 121 includes: an SV linkage unit 122; a device control unit 123 which controls the handset 811-2 serving as a phone receiver in the IP phone functions; and a voice packet communication unit 124.

As storage areas necessary for operations of the softphone 1, there are provided a remote control connection flag area 400, a termination flag area 500, and a terminal IP address storage section 735 in a storage apparatus 725 of the TC server 110. The remote control connection flag area 400 is for a specific bit of a register, and is a flag area for discriminating whether or not a remote control CL 751 is being connected to a remote control SV 726. The remote control SV 726 writes, into the area 400, “0” when the remote control CL 751 is not being connected thereto, and “1” when the remote control CL 751 is being connected thereto. By determination of the remote control connection flag area 400, it is possible to discriminate whether or not the TC terminal 120 is being connected to the TC server 110. The termination flag area 500 is a flag area for notifying the respective processing units to start termination processes when the common processing unit 40 terminates the softphone program according to the embodiment. The common processing unit 40 writes, into the area 500, “0” when the softphone 1 is operated as normal, and “1” when the softphone 1 is forcibly terminated at the time of emergency, such as a termination operation by the user and application anomaly. An IP address of the TC terminal 120 is stored into the terminal IP address storage section 735.

The softphone in FIG. 3 is configured by integrating the normal-version module 20 for realizing the same operation mode as a normal-version softphone and the TC-version module 30 for realizing the same operation mode as a TC-version softphone in the server-side phone control unit 5. Further, the remote control determination processing unit 10 for determining connection or disconnection of the TC terminal of the TC system is incorporated in the server-side phone control unit 5.

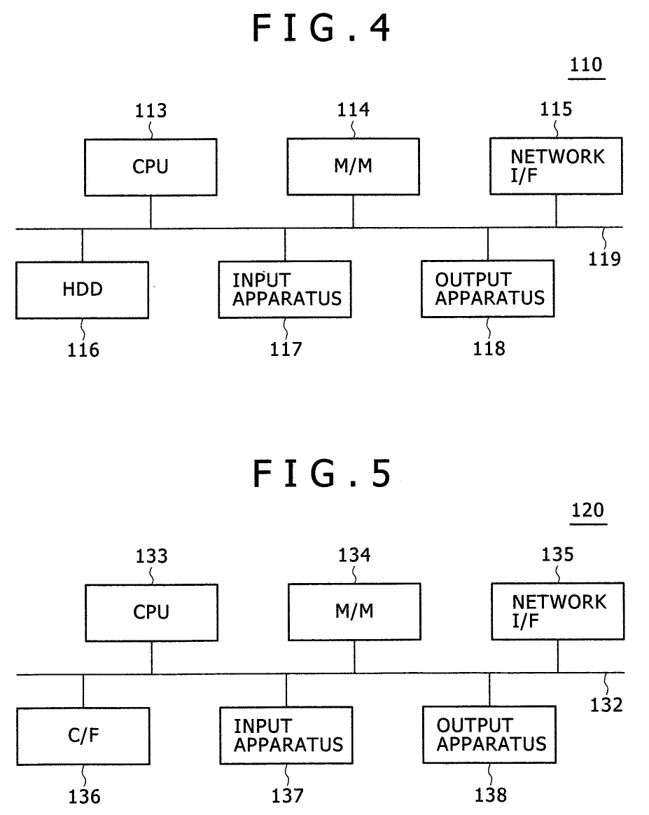

With reference to FIGS. 4 and 5, hardware configurations of the TC server and the TC terminal will be described. FIG. 4 is a hardware block diagram of the TC server. FIG. 5 is a hardware block diagram of the TC terminal.

In FIG. 4, the TC server 110 includes a central processing unit (CPU) 113, a main memory (M/M) 114, a network interface (I/F) 115, an HDD 116, an input apparatus 117, and an output apparatus 118, all of which are connected to a bus 119. The respective functional blocks of the TC server 110 which were described using FIG. 3 are realized by the CPU 113 which executes programs written in the main memory 114.

In FIG. 5, the TC terminal 120 includes a central processing unit (CPU) 133, a main memory (M/M) 134, a network interface (I/F) 135, a compact flash (registered trademark) memory (C/F) 136, an input apparatus 137, and an output apparatus 138, all of which are connected to a bus 132. The respective functional blocks of the TC terminal 120 which were described using FIG. 3 are realized by the CPU 133 which executes programs written in the main memory 134. The compact flash memory 136 is unwritable by a user, and stores therein an OS, a driver, a softphone program, and an Independent Computing Architecture (ICA) client. The ICA client is a program for receiving screen information.

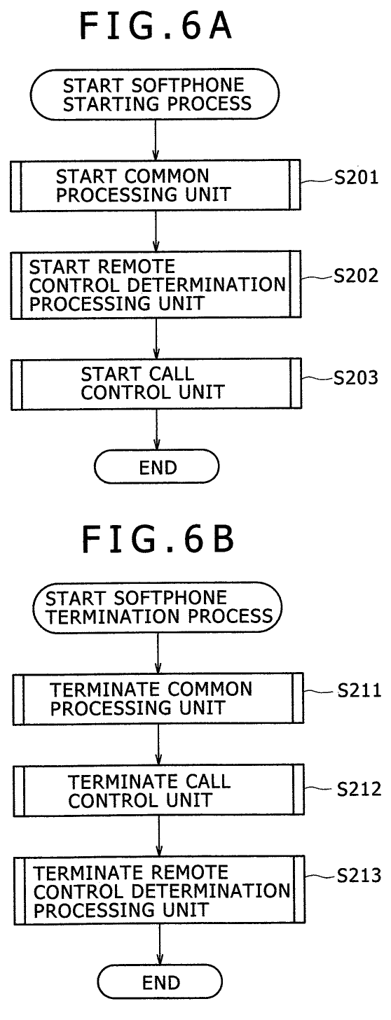

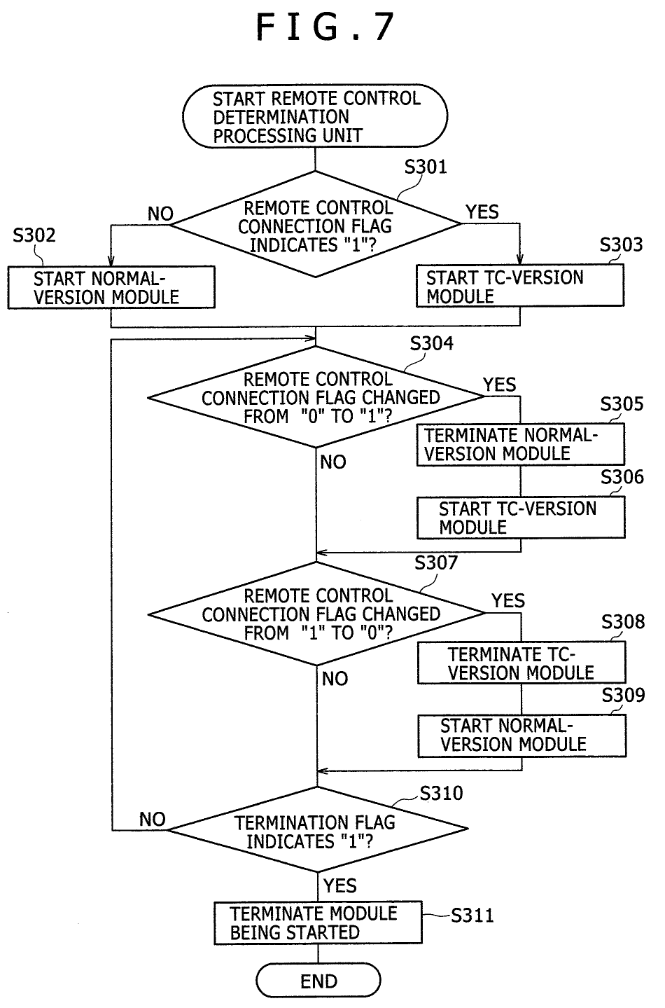

With reference to FIGS. 6A and 6B, a starting process and a termination process of the softphone will be described. FIG. 6A is a flowchart for explaining a starting process of the softphone. FIG. 6B is a flowchart for explaining a termination process of the softphone. The softphone allows the respective processing units to start in accordance with the flowchart in FIG. 6A so as to shift to a state in which phone functional processes such as call dialing, call receiving, and a call can be performed. In the case where a PC user performs a termination operation for the softphone, the softphone allows the respective processing units to terminate in accordance with the flowchart in FIG. 6B.

In FIG. 6A, when the PC user starts the softphone 1, the softphone 1 starts the process. In Step 201, the common processing unit 40 is started. The common processing unit 40 conducts processes such as confirmation of connection or disconnection of a voice device, a registering process to the telephony server 800, and a reset process (writing “0” into the termination flag area 500) of the termination flag for notifying the respective processing units to start termination processes when the application is to be terminated. Next, in Step 202, the softphone 1 starts the remote control determination processing unit 10. The remote control determination processing unit 10 determines connection or disconnection of the TC terminal in the TC system, and starts a softphone module in accordance with the determination result. For the remote control determination processing unit 10, the operational flow thereof will be described in detail using FIG. 7. In Step 203, the softphone 1 starts the call control unit 50. The call control unit 50 performs processes in the softphone 1, such as call dialing, call receiving, and call maintenance, with the telephony server 800. The above-described processes allow the softphone 1 to shift to a state in which phone functional processes such as call dialing, call receiving, and a call can be performed.

In FIG. 6B, when the PC user performs a termination operation for the softphone 1, the softphone 1 starts the process. In Step 211, the softphone 1 executes a process for terminating the common processing unit 40. At this time, the common processing unit 40 conducts an unregistering process to the telephony server 800, writes “1” into the termination flag area 500 reserved in the storage apparatus 725, and terminates the its own process. Next, in Step 212, the softphone 1 executes a process for terminating the call control unit 50. At this time, the call control unit 50 determines the flag indicating “1” in the termination flag area 500 so as to perform its own termination process. In Step 213, the softphone 1 executes a process for terminating the remote control determination processing unit 10. At this time, the remote control determination processing unit 10 determines the flag indicating “1” in the termination flag area 500, terminates the module that is being started, and then performs its own termination process for completion of the flowchart.

FIG. 7 is a flowchart for explaining an operational process of the remote control determination processing unit. In FIG. 7, the remote control determination processing unit 10 starts the process from Step 202 in FIGS. 6A and 6B. In Step 301, the remote control determination processing unit 10 determines “0” or “1” indicated in the remote control connection flag area 400 reserved in the storage apparatus 725 in FIG. 3. If the flag indicates “0” (S301; No), the remote control determination processing unit 10 starts the normal-version module 20 of the server-side phone control unit 5 in Step 302. On the other hand, if the remote control connection flag area 400 indicates “1” in Step 301 (S301; Yes), the remote control determination processing unit 10 starts the TC-version module 30 of the server-side phone control unit 5 in Step 303.

In other words, when the softphone is started, the remote control determination processing unit 10 determines connection or disconnection of the TC terminal. If the TC terminal is not being connected, the normal-version module 20 is started to function as “normal-version mode”. If the TC terminal is being connected, the TC-version module 30 is started to function as “TC-version mode”.

Next, changes in a flag state are monitored in the loop of Steps 304, 307, 310, and 304. When the value of the remote control connection flag area 400 is changed from 0 to 1 in Step 304 (S304; Yes), the normal-version module 20 is terminated in Step 305, and the TC-version module 30 is started in Step 306. When the value of the remote control connection flag area 400 is changed from 1 to 0 in Step 307 (S307; Yes), the TC-version module 30 is terminated in Step 308, and the normal-version module 20 is started in Step 309. Accordingly, in a state where the softphone is being started, the softphone can be used by the TC terminal at the moment when the TC terminal is connected to the TC server, and the softphone can be used by the TC server at the moment when the TC terminal is disconnected. Thus, it is possible for the softphone user to dynamically and automatically switch an operation mode without being aware of switching of the softphone in accordance with the usage environment of the PC.

Further, if the termination flag area 500 indicates “1” in Step 310 (S310; Yes), the normal-version module 20 or the TC-version module 30 that is being started is terminated in Step 311, and all the processes are completed. The process after Step 310 represents that in Step 212 in FIG. 6B. After the common processing unit 40 writes “1” into the termination flag area 500 in Step 211 in FIG. 6B, the process in Step 311 is started.

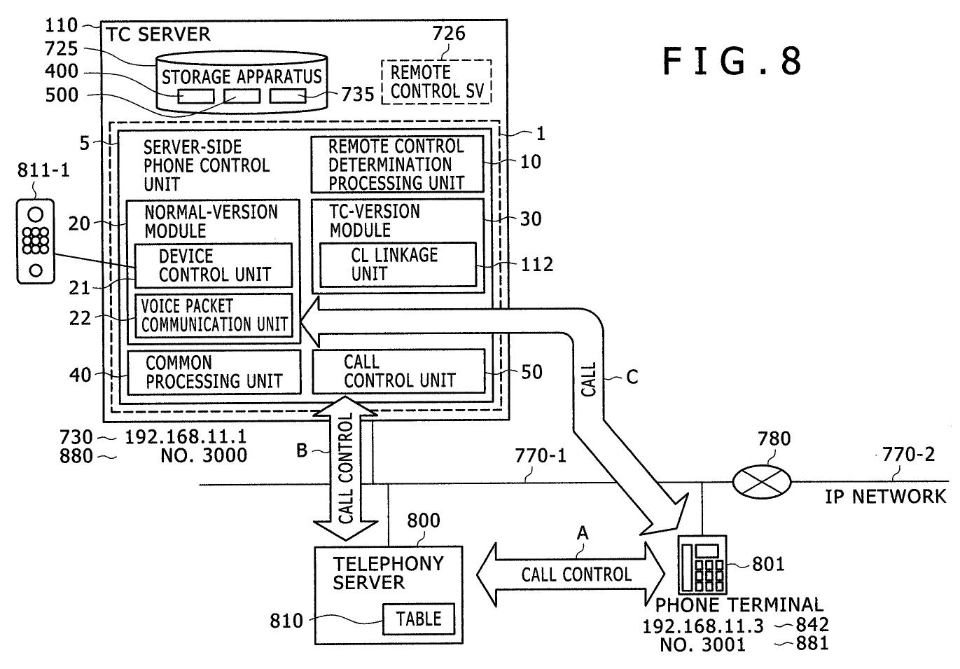

With reference to FIGS. 8 to 11, a basic operation of the softphone according to the embodiment will be described for each case of “normal-version mode” and “TC-version mode”.

FIG. 8 is a block diagram for explaining a call between the phone terminal and the TC server. In FIG. 8, the user directly operates the TC server placed on a user's desk without using the TC terminal. In this case, the remote control determination processing unit of the softphone does not detect connection of the TC terminal, and thus the softphone is allowed to be operated as “normal-version mode”. In this state, an operation in which a dialing call from the phone terminal to the softphone is performed will be described.

As a premise, it is assumed that as IP addresses for discriminating each terminal, an IP address 730 of “192. 168. 11. 1” is set to the TC server 110 and an IP address 842 of “192. 168. 11. 3” is set to the phone terminal 801. Further, it is assumed that as extension numbers for discriminating each phone terminal, an extension number 880 of “3000” is set to the softphone 1, and an extension number 881 of “3001” is set to the phone terminal 801. Furthermore, it is assumed that the telephony server 800 holds a table in which information capable of associating the IP address of each terminal with the extension number of each terminal is stored, and manages each phone terminal.

In FIG. 8, when dialing the extension number 880 (3000) of the softphone 1 from the phone terminal 801, call control information indicated by the arrow A is exchanged between the phone terminal 801 and the telephony server 800. The telephony server 800 searches for an IP address corresponding to the softphone 1 from an IP address list table 810 for each phone terminal which is preliminarily registered as registering information, and exchanges call control information indicated by the arrow B with the call control unit 50 of the softphone 1. At this time, the call control unit 50 of the TC server 110 notifies the phone terminal 801, of the IP address 730 of the TC server 110 as a destination address of the voice packet. The phone terminal 801 transmits and receives the voice packet to/from the voice packet communication unit 22 of the TC server 110, so that a call indicated by the arrow C is realized.

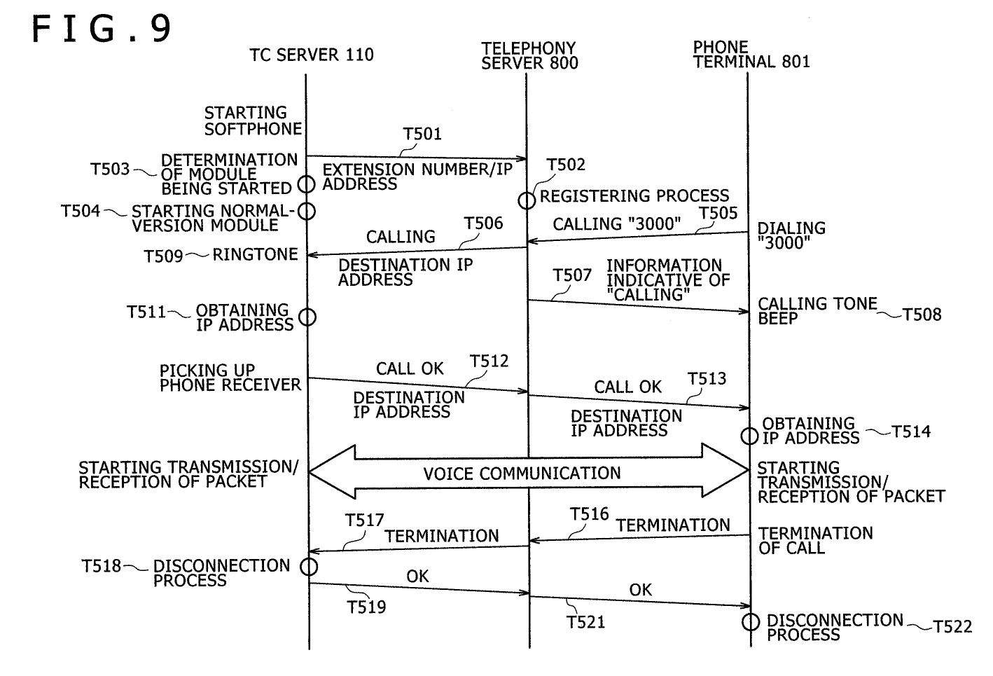

With reference to FIG. 9, the operation of FIG. 8 will be described from the viewpoint of a call control sequence. FIG. 9 is a sequence diagram of call control performed among the TC server, the telephony server, and the phone terminal. In FIG. 9, when the user starts the softphone 1 in the TC server 110 in the first place, the common processing unit 40 notifies the telephony server 800, of the extension number and IP address of the TC server 110 (T501). The telephony server 800 writes the received extension number and IP address, as a set, into the IP address list table 810 (registering process, T502). The remote control determination processing unit 10 determines connection or disconnection of the TC terminal (T503). Since the TC terminal is not being connected in this stage of the sequence, the normal-version module is started (T504).

Now, it is assumed that the user of the phone terminal 801 dials the destination phone number “3000”. The phone terminal 801 transmits call-connection-request information that uses the destination phone number “3000” as a parameter, to the telephony server 800 (T505). When receiving the call-connection-request information, the telephony server 800 refers to the IP address list table 810 so as to specify “192. 168. 11. 1” of the call-connected IP address 730. Then, the telephony server 800 transmits the call-connection-request information that uses the destination IP address 842 as a parameter, to the IP address “192, 168, 11, 1” (T506). The telephony server 800 also transmits information indicative of “calling”, to the phone terminal (T507). The phone terminal 801 that received the information emits a calling tone so as to inform the user of “calling” (T508). Meanwhile, when receiving incoming-call information, the TC server 110 emits a ringtone (T509), and notifies the voice packet communication unit 22 of the destination IP address 842 in the parameter (T511) When the user of the TC server 110 operates a call button of the handset so as to make the TC server 110 ready to call, the TC server 110 sets the IP address 730 of its own, as the destination IP address, to the parameter, and transmits “call OK” to the telephony server (T512). When receiving “call OK”, the telephony server 800 transmits “call OK” including the parameter to the phone terminal 801 (T513). When receiving “call OK”, the phone terminal 801 obtains the destination IP address 730 in the parameter (T514), and sets the destination IP address 730 as a voice packet destination to start transmission of the voice packet. At the same time, the phone terminal 801 starts reception of the packet transmitted from the destination. Meanwhile, when the TC server 110 is ready to call, the TC server 110 sets the notified destination IP address 842 as a voice packet destination to start transmission of the voice packet. At the same time, the TC server 110 starts reception of the packet transmitted from the destination. Accordingly, a direct call can be established between the TC server 110 and the phone terminal 801. In the case of terminating the call, when the user of the phone terminal 801 puts down the phone receiver, the phone terminal 801 transmits termination information to the telephony server 800 (T516). The telephony server 800 that received the termination information transmits the termination information to the TC server 110 (T517). The TC server 110 conducts a disconnection process (T518), and transmits an “OK” notification to the telephony server 800 (T519). The telephony server 800 that received the “OK” notification transfers the “OK” notification to the phone terminal 801 (T521). The phone terminal 801 conducts a disconnection process (T522), and a series of the call process is completed.

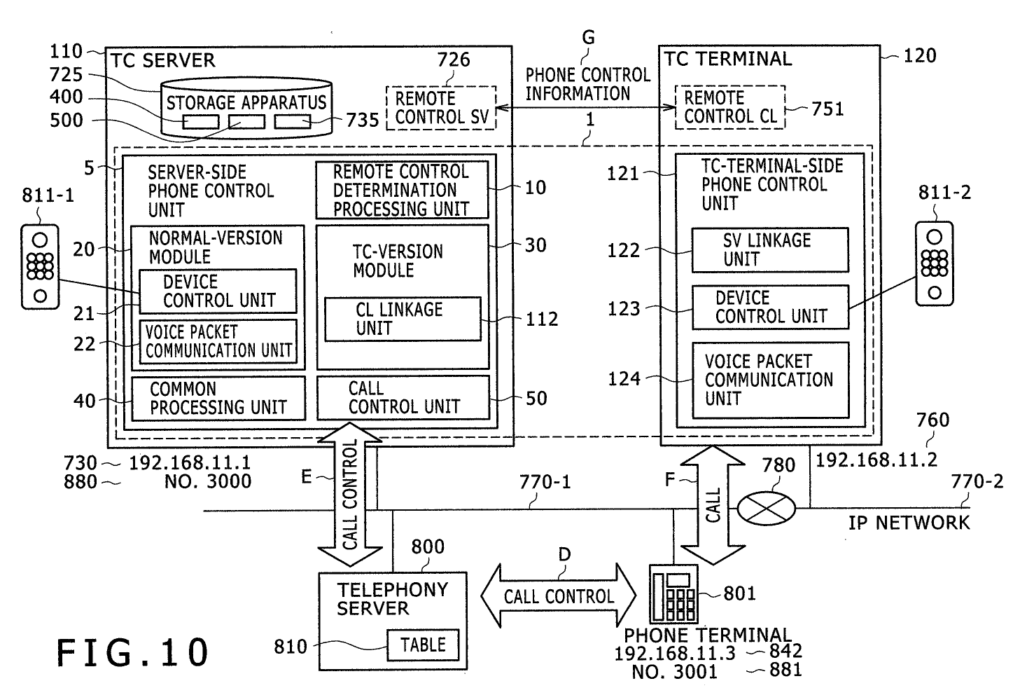

With reference to FIG. 10, there will be described a call when using the TC terminal as the TC system. FIG. 10 is a block diagram for explaining a call between the phone terminal and the TC terminal. In FIG. 10, the remote control determination processing unit 10 of the softphone 1 detects connection of the TC. terminal, and starts the TC-version module to be operated as “TC-version moded”. On the assumption that a dialing call is performed from the phone terminal 801 to the softphone 1 in this state, a basic operation will be described. As a premise, it is assumed that as an IP address for discriminating a terminal, an IP address 760 of “192. 168. 11. 2” is set to a TC terminal 120, other than the conditions described in FIG. 8. Further, it is assumed that the IP address 760 of the TC terminal is preliminarily stored in the terminal IP address storage section 735 of the storage apparatus 725 of the TC server 110.

When dialing the extension number 880 (3000) of the softphone 1 from the phone terminal 801, call control information indicated by the arrow D is exchanged between the phone terminal 801 and the telephony server 800. The telephony server 800 searches for an IP address corresponding to the softphone 1 from the IP address list table 810 for each phone terminal which is preliminarily registered as registering information. The telephony server 800 exchanges call control information indicated by the arrow E with the call control unit 50 of the softphone 1. At this time, the call control unit 50 sets the IP address 760 of the TC terminal 120 stored in the terminal IP address storage section 735 of the storage apparatus 725, as the destination address of the voice packet, and notifies the phone terminal 801 of the IP address 760. Meanwhile, the IP address 842 of the phone terminal 801 is notified to the voice packet communication unit 124 via the CL linkage unit 112, the remote control SV 726, the remote control CL 750, and the SV linkage unit 122 in the softphone 1. The phone terminal 801 transmits and receives the voice packet to/from the voice packet communication unit 124 of the TC terminal 120, so that a call indicated by the arrow F is realized. The call control unit 50 manages call control during a call in the softphone 1 by exchanging phone control information indicated by the arrow G between the CL linkage unit 112 and the SV linkage unit 122.

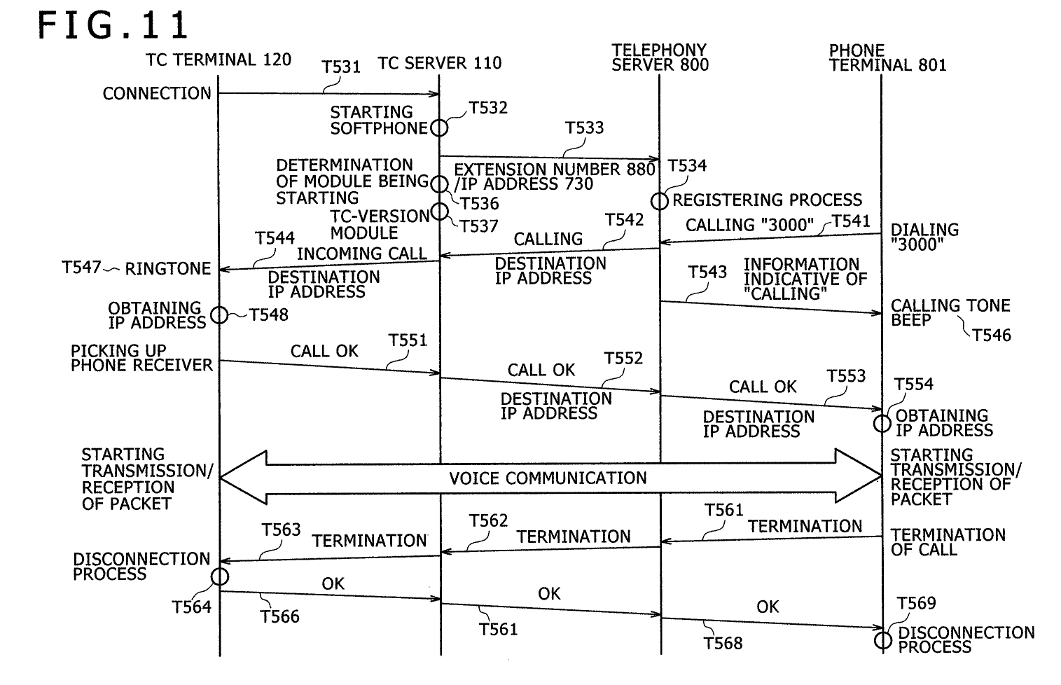

With reference to FIG. 11, the operation in the “TC-version mode” will be described from the viewpoint of a call control sequence. FIG. 11 is a sequence diagram of call control performed among the TC terminal, the TC server, the telephony server, and the phone terminal. When the TC terminal 120 is connected to the network 770-2, the remote control CL 751 of the TC terminal 120 starts to access the remote control SV 725 serving as a main remote control (T531). The TC server 110 that detected the access starts the softphone (T532). The common processing unit 40 of the TC server 110 transmits the extension number and the IP address to the telephony server 800, as a registering process (T533). The telephony server 800 writes the received extension number and IP address, as a set, into the IP address list table 810 (registering process, T534). The remote control determination processing unit 10 of the TC server 120 determines the remote control connection flag area 400 (T536), and recognizes connection of the TC terminal to start the TC-version module (T537).

In this state, if the user of the phone terminal 801 dials the destination phone number “3000”, the phone terminal 801 transmits call-connection-request information that uses the destination phone number “3000” as a parameter, to the telephony server 800 (T541). When receiving the call-connection-request information, the telephony server 800 refers to the IP address list table 810 so as to specify “192. 168. 11. 1” of the call-connected IP address 730. Then, the telephony server 800 transmits the call-connection-request information that uses the destination IP address 842 as a parameter, to the IP address “192, 168, 11, 1” (T542). The telephony server 800 also transmits information indicative of “calling”, to the phone terminal 801 (T543). The phone terminal 801 emits a calling tone (T546), and informs the user of “calling”. Meanwhile, the TC server 110 that received the call-connection-request information notifies the TC terminal 120 of an incoming-call notification and the destination IP address 842 set as a parameter (T544). When receiving the incoming-call information, the TC terminal 120 rings (T547). The voice packet communication unit 124 of the TC terminal 120 obtains the destination IP address 842 in the parameter (T548).

When the user of the TC terminal 120 operates a call button of the handset so as to make the TC terminal 120 ready to call, the TC terminal 120 notifies the TC server of “call OK” (T551). The TC server 110 sets the IP address 760 of the TC terminal 120, as the destination IP address, to the parameter, and transmits “call OK” to the telephony server 800 (T552). When receiving “call OK”, the telephony server 800 transmits “call OK” including the parameter to the phone terminal 801 (T553). When receiving “call OK”, the phone terminal 801 obtains the destination IP address 760 in the parameter (T554). The phone terminal 801 sets the destination IP address 760 as a voice packet destination to start transmission of the voice packet. At the same time, the phone terminal 801 starts reception of the packet transmitted from the destination. Meanwhile, when the TC terminal 120 is ready to call, the TC terminal 120 sets the notified destination IP address 842 as a voice packet destination to start transmission of the voice packet. At the same time, the TC terminal 120 starts reception of the packet transmitted from the destination. Accordingly, a direct call can be established between the TC terminal 120 and the phone terminal 801.

In the case of terminating the call, when the user of the phone terminal 801 puts down the phone receiver, the phone terminal 801 transmits termination information to the telephony server 800 (T561). The telephony server 800 that received the termination information transfers the termination information to the TC server 110 (T562). The TC server 110 transfers the termination information to the TC terminal 120 (T563). The TC terminal 120 that received the termination information conducts a disconnection process (T564), and transmits an “OK” notification to the TC server 110 (T566). The TC server 110 that received the “OK” notification transfers the “OK” notification to the telephony server 800 (T567). The telephony server 800 further transfers the “OK” notification to the phone terminal 801 (T568). The phone terminal 801 that received the “OK” notification conducts a disconnection process (T569), and a series of the call process is completed.

According to the embodiment, an operation mode is automatically switched in accordance with the environment for a user who uses the communication system, thus enhancing the convenience of the softphone for the user.

Further, according to the embodiment, by combining two kinds of existing softphone modules, components of overlapping parts can be integrated. Accordingly, it is possible to suppress the cost lower than that in the case of introducing two kinds of softphones, thus realizing an economic communication system.

The explanation has been made on the assumption that the softphone is used in the “PtoP type” of the TC system configuration. However, even in the case where the softphone according to the embodiment is used in the blade PC type of the screen transfer scheme, the functions described herein are effective. A blade PC is normally installed in a room, such as a server room, where the security is ensured. A user does not enter the room to use the blade PC, but uses the blade PC from a different floor or the like via a network. Thus, it is unthinkable that when using the TC system in the blade PC type, the system is used with a PC placed on a user's desk. Even if the softphone of the embodiment is applied to this case, a call can be received by the TC terminal as the TC-version mode during connection of the TC terminal. However, when the TC terminal is disconnected, a call is received, as the normal-version mode, by the blade PC which is on the TC server side. Accordingly, if there exists an incoming call in this state, the call is received in the server room, which seems to make no sense.

However, if the softphone of the embodiment has a voicemail function, the following scheme is possible because a call can be received on the TC server side; the automatic answering of the voicemail function delivers an absence message to the caller after a certain period of time for incoming call notification, and a message of the caller is recorded into a storage apparatus on the TC server side. A TC-version softphone in the past has no function of processing a voice packet when a call control unit of the TC server detects an incoming call in a state where the TC terminal is disconnected. Therefore, in order to realize the voicemail function in this configuration, it is necessary to introduce a new system in which an additional apparatus serving as a voicemail server is introduced and, when the destination does not answer for a certain period of time, the additional apparatus performs, in cooperation with the telephony server, a process of transferring a massage to the voicemail server for recording. The cost for the system is enormous. Meanwhile, the voicemail function included in the above-described softphone is an already-known technique, and can be easily installed as a general function of the softphone.

Although the embodiment has been described as an example of a phone function using only voice, a TV phone and a TV conference that use voice and video are also already-known techniques, and the same functions can be executed even under the environment with video.

According to the present embodiment, there are provided a thin client system and a communication apparatus in which operations are changed depending on connection or disconnection of a client.

What is claimed is:

1. A thin client system comprising:
a communication apparatus to which a client can be connected via a network and which can execute an application program; and
said client that accesses said application program to output the execution result,
wherein said application program determines connection or disconnection between said communication apparatus and said client, and selects an operation mode depending on a determination result.

2. The thin client system according to claim 1,
wherein said application program transmits and receives voice.

3. A communication apparatus to which a client can be connected via a network,
wherein an application program is executed to determine whether or not said client is being connected, and an operation mode of said application program is selected depending on a determination result.

4. The communication apparatus according to claim 3,
wherein said application program transmits and receives voice.
